(19) United States
(12) Patent Application Publication
(10) Pub. No.: US 2024/0213609 A1
(43) Pub. Date: Jun. 27, 2024

(54) BATTERY PACK FOR VEHICLE

(71) Applicant: TOYOTA JIDOSHA KABUSHIKI KAISHA, Toyota-shi (JP)

(72) Inventors: Shigeyuki Inoue, Toyota-shi (JP); Kensuke Matsuo, Seto-shi (JP)

(73) Assignee: TOYOTA JIDOSHA KABUSHIKI KAISHA, Toyota-shi (JP)

(21) Appl. No.: 18/459,609

(22) Filed: Sep. 1, 2023

(30) Foreign Application Priority Data
Dec. 26, 2022 (JP) 2022-208680

(51) Int. Cl. H01M 50/249; H01M 10/658; H01M 50/209; H01M 50/30; H01M 50/505

(52) U.S. Cl. CPC H01M 50/249; H01M 10/658; H01M 50/209; H01M 50/30; H01M 50/505; H01M 2220/20

(57) ABSTRACT

A battery pack for a vehicle includes a housing mounted on a vehicle, a first battery module accommodated in the housing and having a plurality of battery cells stacked along a first direction, and at least one cushioning material in contact with the first battery module in the housing. The at least one cushioning material is made of a flame retardant material.

### CROSS-REFERENCE TO RELATED APPLICATION

This application claims priority to Japanese Patent Application No. 2022-208680 filed on Dec. 26, 2022, incorporated herein by reference in its entirety.

### BACKGROUND

### 1. Technical Field

The present specification discloses a battery pack for a vehicle mounted on a vehicle.

### 2. Description of Related Art

Japanese Unexamined Patent Application Publication No. 2015-195136 (JP 2015-195136 A) describes a battery module. In this battery module, a plurality of battery cells is stacked along one direction.

### SUMMARY

In a battery pack mounted on a vehicle, one or a plurality of battery modules is accommodated in a housing. Inside the housing, a cushioning material is disposed so as to be in contact with the battery module. The cushioning material is composed of a polymer material having viscoelasticity or the like. The cushioning material protects the battery module from vibrations and shocks caused by the vehicle.

In the battery module, it is known that contents of a battery cell (for example, an electrolytic solution) are ejected at a high temperature when an abnormality such as abnormal heat generation of the battery cell occurs. In this case, a gap present in the housing also serves as a flow path for suppressing high temperature ejections from staying at a specific location in the housing. On the other hand, the above-described cushioning material is also disposed in the gap present in the housing. The high temperature ejections can melt and deform the cushioning material. In this case, the flow of the ejections is inhibited. The present specification provides a technique that can solve or reduce this issue.

A battery pack for a vehicle disclosed in the present specification includes a housing mounted on the vehicle, and a first battery module accommodated in the housing. The battery pack includes the first battery module in which a plurality of battery cells is stacked along a first direction, and at least one cushioning material in contact with the first battery module in the housing. The at least one cushioning material is composed of a flame retardant material.

According to the above configuration, the cushioning material is composed of the flame retardant material. Therefore, the cushioning material is not melted or deformed by the high temperature ejections. As a result, the flow of the ejections is suppressed from being inhibited. Here, the flame retardant material is, for example, a material certified by V-0 or V-1 in the Standard for Safety of Flammability of Plastic Materials for Parts in Devices and Appliances “UL-94”. The standard is a standard developed by Underwriters Laboratories Inc. (UL). Further, the flame retardant material may be a material that is certified to the same degree as V-0 or V-1 in other standards (for example, Japanese Industrial Standards (JIS)) other than the Standard for Safety of Flammability of Plastic Materials for Parts in Devices and Appliances “UL-94”.

Details of the techniques disclosed in the present specification and further modifications will be described in the “DETAILED DESCRIPTION OF EMBODIMENTS” below.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view of a battery pack;

FIG. 2 is an enlarged view of the area II of FIG. 1;

FIG. 3 is a perspective view of the first cushioning material; and

FIG. 4 is a cross-sectional view taken along IV-IV line of FIG. 1.

### DETAILED DESCRIPTION OF EMBODIMENTS

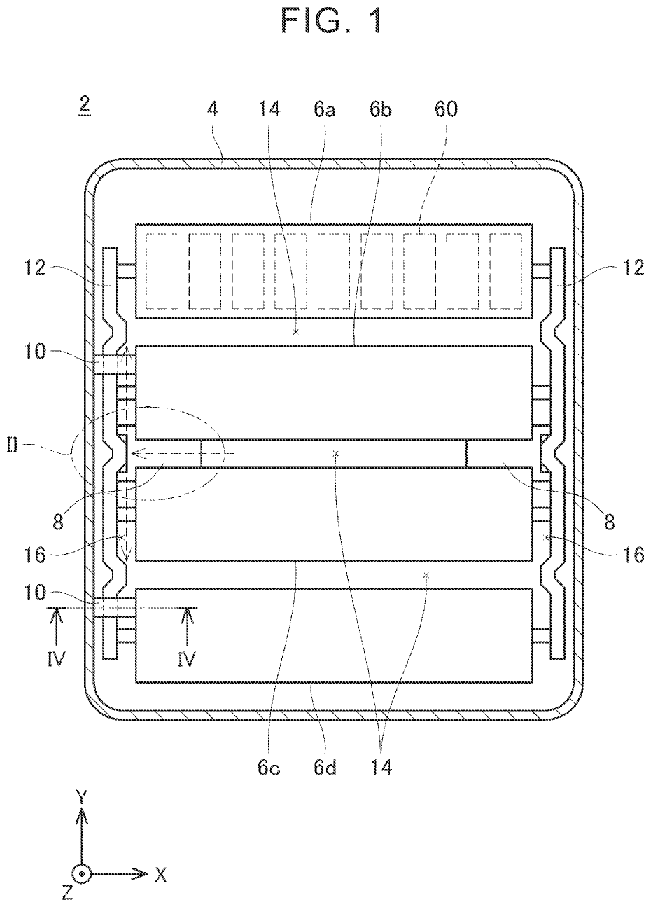

### Configuration of Battery Pack 2; FIG. 1

The battery pack 2 is mounted on a vehicle. The vehicle is a rechargeable vehicle that is charged by an external power source, a hybrid electric vehicle including an engine, and the like. The battery pack 2 includes a housing 4, a plurality of battery module 6a to 6d, a first cushioning material 8, a second cushioning material 10, and a bus bar 12.

FIG. 1 is a plan view showing the housing 4 in cross section. In addition, XYZ coordinates are defined in the drawing.

A plurality of battery-module 6a to 6d is accommodated in the housing 4. In the battery modules 6a to 6d, a plurality of battery cells 60 is stacked along the X-axis. In FIG. 1, one of the plurality of battery cells 60 is denoted by a reference numeral. The other battery cells are not labeled. In addition, in FIG. 1, the battery cell 60 is not depicted in the battery module 6b to 6d.

The plurality of battery modules 6a to 6d is arranged along the Y-axis. For example, the battery module 6a adjoins the battery module 6b in the Y-axis direction.

The bus bar 12 extends along the Y-axis at a position facing the plurality of battery modules 6a to 6d. The end portions of the respective battery modules 6a to 6d in the X-axis direction face the bus bars 12. The bus bar 12 electrically connects the battery module 6a and the battery modules 6b to 6d.

The battery pack 2 of the present embodiment includes two first cushioning materials 8. The one first cushioning material 8 is in contact with both the battery module 6b and the battery module 6c at the end portion in the X-axis positive direction. The other first cushioning material 8 is in contact with both the battery module 6b and the battery module 6c at the opposite end in the X-axis negative direction. The number of the first cushioning materials 8 is not limited to two. The number of the first cushioning materials 8 may be, for example, one, three or more. In addition, the first cushioning material 8 May be disposed at other locations. For example, the first cushioning material 8 May be disposed in the housing 4 so as to be in contact with both the battery module 6a and 6b.

The battery pack 2 of the present embodiment includes two second cushioning materials 10. The one second cushioning material 10 is in contact with an end portion of the battery module 6b in the X-axis positive direction. The other second cushioning material 10 is in contact with an end portion of the cell module 6d in the X-axis positive direction. The number of the second cushioning materials 10 is not limited to two. The number of the second cushioning materials 10 May be, for example, one, three or more. The second cushioning material 10 May be disposed at other locations. The second cushioning material 10 May be disposed in the housing 4 so as to be in contact with the battery module 6a, for example.

The first cushioning material 8 and the second cushioning material 10 are made of a polymer material having viscoelasticity or the like. The first cushioning material 8 and the second cushioning material 10 protect the respective battery module 6a to 6d from vibrations and impacts generated in vehicles. Further, the materials of the first cushioning material 8 and the second cushioning material 10 have flame retardancy. Here, the flame retardant material is, for example, a material certified by V-0 or V-1 in the Standard for Safety of Flammability of Plastic Materials for Parts in Devices and Appliances “UL-94”. The material is, for example, “Sunforce (registered trademark)” manufactured by Asahi Kasei Corporation.

In addition, when an abnormality such as abnormal heat generation of the battery cell 60 occurs, the contents of the battery cell 60 (for example, an electrolytic solution) may be ejected at a high temperature. Defined within the housing 4 is an ejection flow path for guiding hot ejections from the battery cells 60. Specifically, there is a gap 14 between neighboring battery modules and battery modules (e.g., 6a and 6b). There is a gap 16 between the end portion of the respective battery module 6a to 6d in the X-axis direction and the bus bar 12. The gap 14 and the gap 16 function as an ejection flow path. For example, the gap 16 includes a gap between the battery module 6a and the bus bar 12 and a gap between the battery module 6b and the bus bar 12. The gaps are in communication with each other.

For example, as indicated by the broken-line arrow in FIG. 1, the ejection ejected from the battery cell 60 flows from the gap 14 to the gap 16. This prevents hot ejections from staying at specific locations within the housing 4. For example, the bus bar 12 is fragile in heat resistance. The ejection flow path can protect the bus bar 12 from hot ejections.

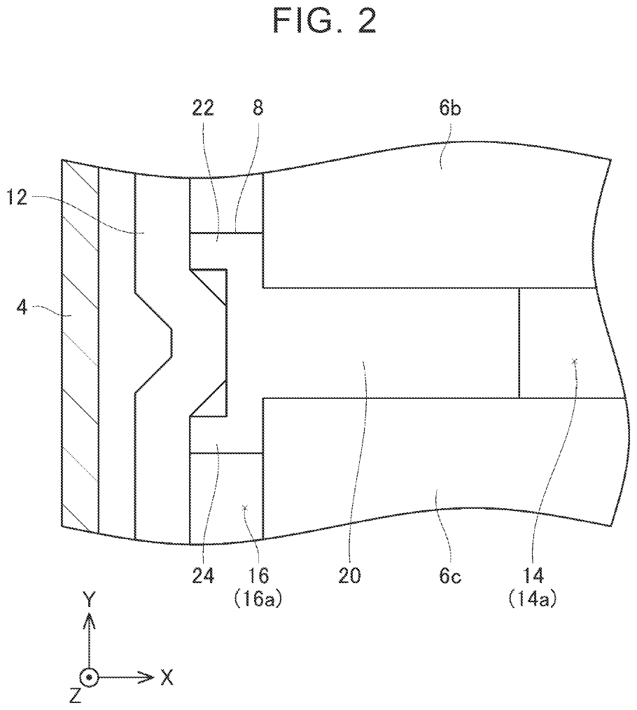

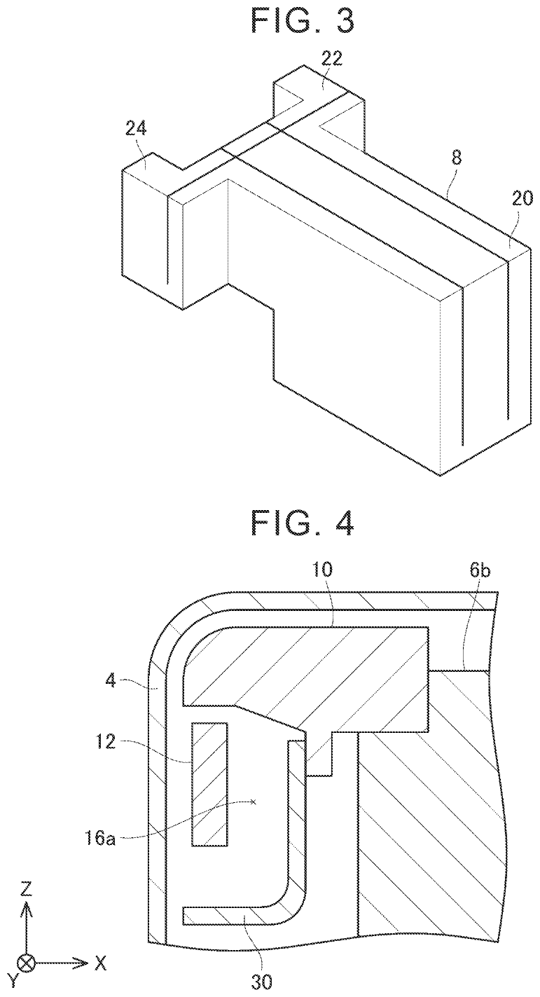

### First cushioning material 8; FIG. 2, FIG. 3

The first cushioning material 8 includes a first portion 20, a second portion 22, and a third portion 24. The first portion 20 extends in the X-axis direction. The second portion 22 extends in the Y-axis positive direction starting from the first portion 20. The third portion 24 extends in the Y-axis negative direction starting from the first portion 20. As shown in FIGS. 2 and 3, the first cushioning material 8 has a T-shape in a plan view.

The first portion 20 is located in a space on the upper side (i.e., the positive Z-axis direction side) of the gap 14. The first portion 20 is in contact with an outer surface of the battery module 6b on the Y-axis negative direction side and an outer surface of the battery module 6c on the Y-axis positive direction side in the upper space. The lower space of the gap 14 is the first section 14a which is a part of the ejection flow path. The first portion 20 faces from above in the first section 14a of the ejection flow path.

The second portion 22 is located between the end face of the battery module 6b and the bus bar 12. The third portion 24 is located between the end face of the battery module 6c and the bus bar 12. Both the second portion 22 and the third portion 24 are located in the space on the upper side of the gap 16. The lower space of the gap 16 is the second section 16a which is a part of the ejection flow path. The second portion 22 and the third portion 24 face the second section of the ejection flow path from above.

The first cushioning material 8 prevents contact between the battery module and the battery module, and between the battery module and the bus bar 12. Therefore, the battery module can be protected from vibration or the like by the first cushioning material 8. Second cushioning material 10; FIG. 4

The second cushioning material 10 is sandwiched between an end portion of the battery module 6b in the X-axis direction and an inner surface of the housing 4. The second cushioning material 10 passes over the bus bar 12. As shown in FIG. 4, the second section 16a is defined between the bus bar 12 and the fixing plate 30. The fixing plate 30 fixes the respective battery module 6a to 6d to the housings 4 via fastening members such as bolts. As shown in FIG. 4, the second cushioning material 10 faces from above in the second section 16a. In FIG. 1 and FIG. 2, the fixing plate 30 is not shown.

The second cushioning material 10 prevents contact between the battery module and the inner surface of the housing 4. Therefore, the battery module can be protected from vibration or the like by the second cushioning material 10.

### Effect of this Example

According to the configuration of the present embodiment, the first cushioning material 8 and the second cushioning material 10 are made of a material having flame retardancy. Therefore, the first cushioning material 8 and the second cushioning material 10 are not melted and deformed by the high-temperature ejections. As a result, the flow of the ejections is suppressed from being inhibited.

In addition, the first cushioning material 8 and the second cushioning material 10 are disposed in the gaps 14 and 16 existing in the housing 4. Therefore, the battery module 6a to 6d is protected. On the other hand, the gaps 14 and 16 present in the housing 4 also function as an ejection flow path. In the present embodiment, the first cushioning material 8 and the second cushioning material 10 are disposed in the gaps 14 and 16. However, the first cushioning material 8 and the second cushioning material 10 do not block all of the gaps 14 and 16, and are disposed in the space above the gaps 14 and 16. The space below the gaps 14 and 16 serves as an ejection flow path. In this way, both of protecting the battery module 6a to 6d and securing the ejection flow path can be achieved. Correspondence

The battery pack 2, the housing 4, the battery module 6b, the battery module 6c, and the bus bar 12 are exemplary of “battery pack”, “housing”, “first battery module”, “second battery module”, and “bus bar”, respectively. The battery cell 60 is an example of a “battery cell”. The X-axis direction and the Y-axis direction are examples of the “first direction” and the “second direction”, respectively. The first section 14a and the second section 16a are exemplary “first section” and “second section”, respectively. At least one of the first cushioning material 8 and the second cushioning material 10 is an example of “at least one cushioning material”. The first cushioning material 8, the first portion 20, the second portion 22, and the third portion 24 are examples of the “first cushioning member”, the “first portion”, the “second portion”, and the “third portion”, respectively. The second cushioning material 10 is an example of a “second cushioning material”.

In the following, points to be noted regarding the technology shown in the examples will be described. Either of the first cushioning material 8 and the second cushioning material 10 May be disposed in a gap in the housing 4 that does not function as an ejection flow path. In other words, one of the first cushioning material 8 and the second cushioning material 10 May not face the ejection flow path.

The first cushioning material 8 May have any one of the first portion 20, the second portion 22, and the third portion. For example, the first cushioning material 8 May be a rod-shaped member disposed between the battery module 6a and the battery module 6b. Further, for example, the first cushioning material 8 May be a rod-shaped member disposed between the battery module 6a and the bus bar 12.

The battery pack 2 May not include the first cushioning material 8. Further, the battery pack 2 May not include the second cushioning material 10.

Although the specific examples have been described in detail above, these are merely examples and do not limit the scope of claims. The techniques described in the claims include various modifications and alterations of the specific examples illustrated above. The technical elements described in this specification or in the drawings may be used alone or in various combinations. They are not limited to the combinations recited in the claims as filed. Further, the technology illustrated in the present specification or the drawings can achieve a plurality of objects at the same time. However, they have technical usefulness in achieving one of the objectives.

What is claimed is:

1. A battery pack for a vehicle, the battery pack comprising:
a housing mounted on the vehicle;
a first battery module accommodated in the housing and in which a plurality of battery cells is stacked along a first direction; and
at least one cushioning material in contact with the first battery module in the housing, wherein the at least one cushioning material is composed of a flame retardant material.

2. The battery pack according to claim 1, wherein:
in the housing, an ejection flow path for guiding an ejection to be ejected from the first battery module at an abnormal time is defined; and
the at least one cushioning material faces the ejection flow path.

3. The battery pack according to claim 2, further comprising a second battery module accommodated in the housing and in which the battery cells are stacked along the first direction, wherein:
the second battery module is adjacent to the first battery module in a second direction orthogonal to the first direction;
the ejection flow path includes a first section extending along the first direction between the first battery module and the second battery module;
the at least one cushioning material includes a first cushioning material;
the first cushioning material includes a first portion located between the first battery module and the second battery module; and
the first portion of the first cushioning material faces the first section of the ejection flow path from above.

4. The battery pack according to claim 3, further comprising a bus bar extending along the second direction at a position facing the first battery module and the second battery module, wherein:
the first cushioning material includes a second portion located between the first battery module and the bus bar, and a third portion located between the second battery module and the bus bar;
the ejection flow path passes between the first battery module and the bus bar and between the second battery module and the bus bar, and further includes a second section extending along the second direction; and
the second portion and the third portion of the first cushioning material face the second section of the ejection flow path from above.

5. The battery pack according to claim 2, further comprising:
a bus bar extending along a second direction orthogonal to the first direction at a position facing the first battery module;
the ejection flow path further includes a second section extending along the second direction between the first battery module and the bus bar;
the cushioning material includes a second cushioning material;
the second cushioning material is sandwiched between the first battery module and the housing, and passes above the bus bar; and
the second cushioning material faces the ejection flow path from above.
